(19) United States
(12) Patent Application Publication
(10) Pub. No.: US 2025/0058161 A1
(43) Pub. Date: Feb. 20, 2025

(54) A METHOD FOR FIREFIGHTING BY USE OF A FIREFIGHTING FOAM

(71) Applicant: DAFO FOMTEC AB, TYRESÖ (SE)

(72) Inventors: John-Olav OTTESEN, SANDEFJORD (NO); Jan-Erik JÖNSSON, LUND (SE)

(73) Assignee: DAFO FOMTEC AB, TYRESÖ (SE)

(21) Appl. No.: 18/710,980

(22) PCT Filed: Nov. 18, 2022
(86) PCT No.: PCT/SE2022/051080

§ 371 Date: May 16, 2024

(30) Foreign Application Priority Data
Nov. 19, 2021 (SE) 2151411-2

(51) Int. Cl. A62D 1/02; A62C 5/027

(52) U.S. Cl. CPC A62D 1/0071; A62C 5/027

(57) ABSTRACT

The present disclosure provides a method for firefighting by use of a firefighting foam. The present disclosure also provides a firefighting system comprising a water supply line, a foaming concentrate dispenser unit and a polymer dispenser unit.

### FIELD OF THE INVENTION

The present invention relates to a method for firefighting by use of a firefighting foam, especially such a method when using a foaming concentrate which is a fluorine-free foaming concentrate.

### TECHNICAL BACKGROUND

In general, the present invention refers to firefighting systems and methods in which a firefighting foam is created by combining a foaming concentrate to a continuous water supply stream, and where the firefighting foam is then created continuously in the water supply stream.

The present invention refers to the type of firefighting systems existing as permanent installations on e.g. large ships, certain chemical industry plants or at off-shore installations, such as an oil platform or the like.

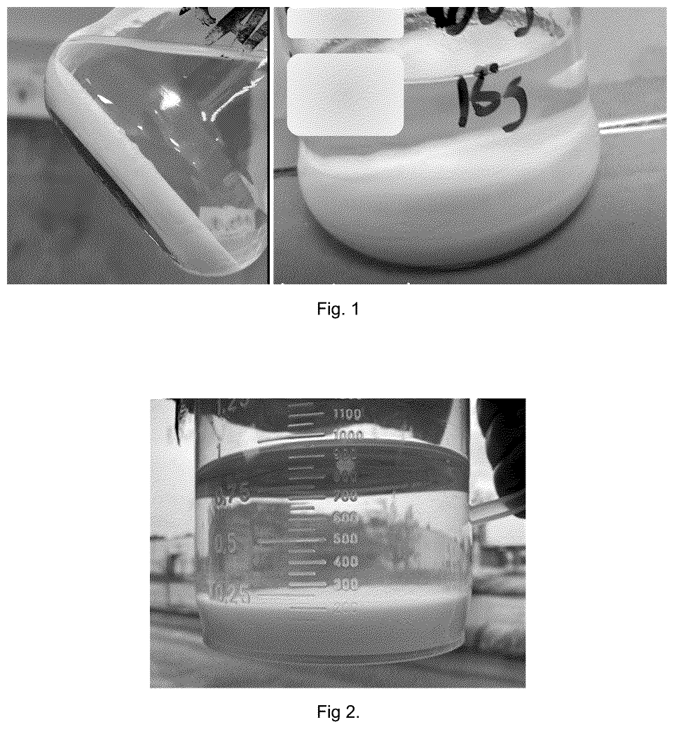

There are existing systems and methods in this field. As an example, in WO 2020/144579 there is disclosed a method of forming a firefighting foam, where the method comprises foaming a first foam solution stream to provide a first finished foam, where the first foam solution stream comprises a base foam concentrate and a dilution water stream, then modifying the first foam solution stream to include a fire suppression additive to form a modified foam solution stream, and finally foaming the modified foam solution stream to form a second finished foam. One system therefore is disclosed in FIG. 1A, which system has a foam injection system 100 with a foam concentrate tank 112, a fluorinated additive tank 114 and a water source 102.

Moreover, in WO 2013/180627 there is disclosed a device for an injector in the interesting field for the present invention. In the description it is mentioned that injectors are intended to mix foam liquid in water to form a premix, which is used for firefighting purposes. Such known injectors are frequently occurring and are used for stationary as well as portable applications. The so-called intermediate injector makes it possible to suck foam liquid in the form of a concentrate from an open vessel and to dose said foam liquid into a pressurized conduit. However, said intermediate injector requires a pressure drop between incoming and outgoing conduit of about 33%, but said injector has a fixed flow.

In WO 2013/180627 it is further said that it is necessary to obtain broader flow ranges, since newer foam liquids are developed. Previously, there were only foam liquids, which were approved for admixtures of 3% and 6%, but now there are foam liquids, which are approved for 1% and even less. Such an intermediate injector, which is well developed, may dose up to about 10% with an acceptable pressure drop.

WO98/19743 discloses biodegradable foam compositions for extinguishing fires. The compositions are stored in concentrated form, as liquid concentrates or powder concentrates, until used. The liquid concentrates contain water, which influences the storage stability of the formulation. The powder concentrates require high energy demanding drying processes and equipments to increase storage stability. The concentrates include high amounts of glycols in order to try to avoid stability issues and solidification, and the manufacturing processes include drying processes.

US2021/0154512 discloses firefighting extinguishing composition and its method of manufacture, wherein a foaming agent and a firefighting foam preservative composition is used. The firefighting foam preservative composition comprises water, a suspension agent, and two different polysaccharides with different solubilities, one being soluble in the suspension agent and the other is not. As the firefighting foam preservative composition comprises water in contact with the polysaccharides there will be stability issues involved with the formulations. It is to be noted that water in contact with polysaccharides will increase viscosity of the composition obtained, and it may be difficult to use in existing firefighting foam mixing and distribution systems, where e.g. pumping means may have difficulties or not being able to secure sufficient extinguishing properties due to the properties of the high viscous composition.

One aim of the present invention is to provide an improved method and system for firefighting by use of a firefighting foam in the general field discussed above. The present invention is especially directed to such an improved method and system for fluorine-free foaming concentrate, also with such concentrations mentioned above, i.e. 1%, 3% and 6% or in between with reference to the fluorine-free foaming concentrate.

### SUMMARY OF THE INVENTION

The present invention provides a way to in an efficient way use existing firefighting foam mixing and distribution systems, maybe with only minor modifications, and avoid storage stability issues of fire extinguishing formulations or high-energy consuming manufacturing methods, and improve the fire extinguishing performance, even for fuels normally difficult to extinguish with fluorine-free foam compositions. The stated purposes above are achieved by a method for firefighting by use of a firefighting foam, said method comprising adding a water-soluble polymer in solid form to a water supply stream, or adding the water-soluble polymer in solid form to an intermediate stream before or when the intermediate stream is being added to the water supply stream, and wherein the water supply stream provides an output of the firefighting foam or is flown to a main water supply stream which in turn provides the output of the firefighting foam.

In relation to the above, some definitions may be discussed further. First of all, “a water-soluble polymer” should be regarded as a substance that dissolve, disperse or swell in water and thus modify the physical properties of an aqueous system by gelation, thickening, emulsification and/or stabilization. In relation to the present invention the water-soluble polymer has the purpose of ensuring one or several of these properties so that a foam concentrate can provide a foam when being combined with a water supply stream.

The scope of the present invention is defined by the appended claims.

Moreover, the core of the present invention is directed to adding the water-soluble polymer in a solid form in a firefighting system. The water-soluble polymer in solid form may be a powder. The water-soluble polymer may be one or more water soluble polymers. The water-soluble polymer is preferably provided as such in the present method, i.e., without being combined with other components used in firefighting such as e.g., surfactants, or glycols, prior to being provided and used in the present method. The water-soluble polymer in solid form may be provided in dry form, such as a dry powder. This implies that the water-soluble polymer is added to a corresponding premix, such as mentioned above, in its solid form. The water-soluble polymer in solid form, surfactants, water, and additional compounds provide the premix which is used in firefighting and provide a foam output, e.g., upon exit through a foam providing nozzle. This implies that the content of the water-soluble polymer and thus the firefighting performance may be enhanced considerably in firefighting systems used today, where this otherwise is impossible. In systems today such content levels of a water-soluble polymer, such as e.g. xanthan gum or the like, is not possible to add. Such levels would not be possible with reference to practical limitation referring to viscosity restrictions and stability properties. By regular addition of such components today it is impossible to obtain a stable and functional system. The present invention provides an important improvement for existing systems today, but also by providing a solution for low concentrated fluorine-free foam concentrates, such as at most 3% concentrates, 0.5-3% concentrates, 1-3% concentrates 1-2% concentrates, or around 1% concentrates. This is further explained and exemplified below.

As may be noted above, according to the present invention the water-soluble polymer in solid form may be added either directly into the water supply stream or into an intermediate stream before or when the intermediate stream is being added to the water supply stream which either is a by-pass stream or in fact is the stream providing output of the firefighting foam. Therefore, the water supply stream may in fact be a by-pass stream which in turn is flown to a main water supply stream which provides the output of the firefighting foam.

As a background, the following may be mentioned. A high-performance fluorine-free foam concentrate contains up to about 1.8% gum, or the like, as a 3% concentrate. This level of gum provides a practical limit with reference to viscosity restrictions and stability properties as mentioned above.

This content level implies that a premix contains about 0.6 g per liter. In a 1% fluorine-free foam concentrate this level would need about 5.5% gum. This is not possible to provide as stable and functional system with conventional known methods. The present invention, however, provides a solution for such an intended system which is stable and functional. The present invention enables to provide high content levels of a water-soluble polymer, such as a gum, in a firefighting system where this is impossible today. This can improve the firefighting performance dramatically.

As should be understood from above, the core of the present invention is the addition of the water-soluble polymer, such as a gum substance, in solid form, suitably as a powder, to the firefighting system. This foundation enables for the provision of stable and functional 1% fluorine-free foam concentrates, intended for all flammable liquid fires, including such based on water-soluble fuels, e.g., alcohols and ketones, with the intended level of water-soluble polymer, such as a gum. Moreover, the present invention also provides an improvement for all types of concentrates as the content level of the water-soluble polymer may be increased in a premix or corresponding stream.

The present invention relates to a method for firefighting by use of a firefighting foam, said method comprising adding a water-soluble polymer in solid form to a water supply stream, or adding the water-soluble polymer in solid form to an intermediate stream before or when the intermediate stream is being added to the water supply stream, and wherein the water supply stream provides an output of the firefighting foam or is flown to a main water supply stream which in turn provides the output of the firefighting foam.

According to one embodiment a foaming concentrate is added to the water supply stream before, simultaneously or after the water-soluble polymer in solid form is added to the water supply stream or before, simultaneously or after the intermediate stream is added to the water supply stream.

According to one embodiment the foaming concentrate is a fluorine-free foaming concentrate.

According to one embodiment the water supply stream provides the output of the firefighting foam.

According to one embodiment the water-soluble polymer in solid form comprises particles and/or granules, preferably is contained in a powder, preferably is a powder, preferably is a powder being able to flow freely.

According to one embodiment the water-soluble polymer is a natural polymer, preferably the water-soluble polymer in solid form is selected from the group consisting of hyaluronic acid; polyglutamic acid; alginic acid; alginates, such as sodium alginate or propylene glycol alginate; agar; carrageenan; galactomannan; glucomannan; starch; cellulose, such as methylcellulose, hydroxy ethylcellulose, or hydroxy propyl methylcellulose; gelatin; succinoglucan; pectin; gum, such as gum arabic, guar gum, welan gum, rhamsam gum, locust bean gum, tara gum, gellan gum, xanthan gum, acacia gum, diutan gum, chitosan gum, gum guaicum, neem gum, pistacia lentiscus gum, caranna, gum tragacanth, karaya gum, beta-glucan gum, chicle gum, kino gum, dammar gum, mastic gum, spruce gum, cassia gum, fenugreek gum, konjac gum, or ghatti gum; pysllium seed husk; or a derivative or modification thereof, or a combination thereof.

The present invention relates to a method for forming a firefighting foam, said method comprising:
adding a water-soluble polymer in solid form to a water supply stream or adding the water-soluble polymer in solid form to an intermediate stream before or when being added to the water supply stream;
adding a foaming concentrate to the water supply stream before, simultaneously or after the water-soluble polymer in solid form is added to the water supply stream, adding the foaming concentrate to the water supply stream before, simultaneously or after the intermediate stream is added to the water supply stream, or wherein the foaming concentrate is part of the intermediate stream,
   and wherein the water supply stream provides an output of the firefighting foam or is flown to a main water supply stream which in turn provides the output of the firefighting foam.

According to one embodiment the foaming concentrate is a fluorine-free foaming concentrate.

According to one embodiment the water supply stream provides the output of the firefighting foam.

According to one embodiment the water-soluble polymer in solid form comprises particles and/or granules, preferably is contained in a powder.

According to one embodiment the water-soluble polymer in solid form is a natural polymer.

According to one embodiment the water-soluble polymer in solid form is added directly into the water supply stream.

According to one embodiment the water-soluble polymer in solid form is added directly into the water supply stream in an adding point which differs from an adding point where the foaming concentrate is added into the water supply stream.

According to one embodiment the water-soluble polymer in solid form is added into a foaming concentrate stream when the foaming concentrate stream is flown into the water supply stream.

According to one embodiment the water-soluble polymer in solid form is added into an aid stream when the aid stream is flown into the water supply stream or when the aid stream is flown into a foaming concentrate stream when the foaming concentrate stream is flown into the water supply stream.

According to one embodiment the water-soluble polymer in solid form is added into an aid stream when the aid stream is flown into the water supply stream and wherein the aid stream is added in an adding point which differs from an adding point for the foaming concentrate into the water supply stream.

According to one embodiment the aid stream comprises a water-soluble medium which inhibits the water-soluble polymer in solid form to dissolve and/or swell.

According to one embodiment the aid stream comprises glycol, butyl diglycol, mono ethylene glycol, mono propylene glycol, polyethylene glycol, butyl glycol, hexylene glycol, ethanol or isopropyl alcohol, propylene glycol monobutyl ether, dipropylene glycol methyl ether, 1-methoxy-2-propanol, methanol, n-propanol, t-butyl alcohol, diethylene glycol, or a combination thereof.

According to one embodiment the water-soluble polymer in solid form is a natural polymer, preferably is a polysaccharide, more preferably wherein the water-soluble polymer in solid form is selected from the group consisting of hyaluronic acid; polyglutamic acid; alginic acid; alginates, such as sodium alginate or propylene glycol alginate; agar; carrageenan; galactomannan; glucomannan; starch; cellulose, such as methylcellulose, hydroxy ethylcellulose, or hydroxy propyl methylcellulose; gelatin; succinoglucan; pectin; gum, such as gum arabic, guar gum, welan gum, rhamsam gum, locust bean gum, tara gum, gellan gum, xanthan gum, acacia gum, diutan gum, chitosan gum, gum guaicum, neem gum, pistacia lentiscus gum, caranna, gum tragacanth, karaya gum, beta-glucan gum, chicle gum, kino gum, dammar gum, mastic gum, spruce gum, cassia gum, fenugreek gum, konjac gum, or ghatti gum; pysllium seed husk; or a derivative or modification thereof, or a combination thereof; preferably selected from the group consisting of sodium alginate, carrageenan, gum arabic, galactomannan, guar gum, welan gum, rhamsam gum, locust bean gum, cellulose, glucomannan, tara gum, gellan gum, xanthan gum, acacia gum, diutan gum, chitosan gum, gelatin, alginic acid, succinoglucan, ghatti gum, methyl cellulose, hydroxy ethylcellulose, hydroxy propyl methylcellulose, pectin, starch, or a derivative or modification thereof, or a combination thereof.

According to one embodiment the water-soluble polymer in solid form is added as a powder in said method, preferably said powder being able to flow freely, at least when subjected to forces.

The present invention relates to a firefighting system comprising:
a water supply line;
a foaming concentrate dispenser unit connected to the water supply line; and
a polymer dispenser unit containing a water-soluble polymer in solid form, said polymer dispenser unit being connected to the water supply line or to an intermediate supply line being connected to the water supply line.

According to one embodiment the system also comprises two separate supply lines in connection with the water supply line, wherein the foaming concentrate dispenser unit is connected to one of said two separate supply lines and wherein the polymer dispenser unit is connected to the other of said two separate supply lines.

According to one embodiment the foaming concentrate dispenser unit and the polymer dispenser unit are connected to one and the same supply line which in turn is connected to the water supply line.

According to one embodiment the water supply line is connected to a main water supply line.

### DETAILED DESCRIPTION WITH SPECIFIC EMBODIMENTS OF THE INVENTION

Below, some specific embodiments of the present invention are disclosed and discussed further.

According to one embodiment, a foaming concentrate is added to the water supply stream before, simultaneously or after the water-soluble polymer in solid form is added to the water supply stream or before, simultaneously or after the intermediate stream comprising a water-soluble polymer is added to the water supply stream. According to the present invention there are different ways to ensure that the foaming concentrate is combined with the water-soluble polymer in solid form when a firefighting foam is intended to be produced and flown out from a main water supply stream. As may be understood the foaming concentrate and water-soluble polymer in solid form may be combined first in a mixing point in the water supply stream, either in a simultaneous adding or by any of the two first being added to the water supply stream.

According to one preferred embodiment, the foaming concentrate is a fluorine-free foaming concentrate.

Moreover, according to yet another embodiment of the present invention, the water supply stream provides the output of the firefighting foam. In this case the water supply stream is the main output stream, however it should be noted that multiple water streams may be used in the method according to the present invention.

The water-soluble polymer may be provided in different forms. According to one embodiment, the water-soluble polymer in solid form comprises particles and/or granules, preferably is contained in a powder. In this regard it should be noted that any solid form is possible according to the present invention, however powders are preferred. Such a powder may be regarded to contain solid material where the particle diameter may vary in different distribution ranges. Both fine particles and larger solids are possible. The water-soluble polymer in solid form may be in particle form, such as granules, aggregates, or powder, preferably in powder form.

The water-soluble polymer in solid form is preferably not to be combined or mixed with firefighting components e.g., water, surfactants, foam booster components, and/or water-soluble medium used in firefighting before being introduced into the present method or system.

The water-soluble polymer in solid form is provided and added in solid form when used in accordance with the present invention. The water-soluble polymer in solid form is preferably added and used as it is in the present method. When the water-soluble polymer in solid form is used in the present method it is added as the main component at the provision or addition point it is added, i.e., it has not been admixed with additional firefighting components in dry, wet, or liquid form, before it's introduction and use in the present process. This means that the water-soluble polymer in solid form is e.g., not to be provided as a part of a slurry or being used and added as such a slurry. The water-soluble polymer in solid form is preferably used in the present invention as it is, i.e., according to the invention the water-soluble polymer in solid form is added in the present process as the particles themselves, e.g., as a powder. Naturally, the water-soluble polymer in solid form, if bought as a commersial product, may contain elements from its manufacture, without diverging form the scope of protection. The water-soluble polymer in solid form, at the point of provision or addition of the polymer, said polymer has prior not been mixed with other firefighting components such as water, surfactants, firefighting boosters, or water-soluble medium used in firefighting, i.e., the water-soluble polymer may be considered to be added separate from other firefighting components, or alone, at a position of said method. The water-soluble polymer in solid form may be one or more specific water-soluble polymers in solid form and does not contain or is combined and optionally stored with any measurable amounts of water, surfactants, or water-soluble medium used in firefighting before being used in the present methods. At the point of addition of water-soluble polymer in solid form in accordance with the present methods of the invention the water-soluble polymer in solid form is simply one or more water-soluble polymers in solid form. In the methods of the present invention water-soluble polymer in solid form is added and used as it is, without having been admixed with other firefighting components, and optionally stored before being used therein.

The water-soluble polymer in solid form may be one or more water soluble polymers, i.e., it may be a combination of water-soluble polymers. The water-soluble polymer in solid form may be considered as a composition comprising one or more specific water-soluble polymer in solid form. However, such a composition comprising one or more specific water-soluble polymer in solid form should not contain any additional firefighting compounds. Such a composition may then be added to a foaming concentrate, a water stream, an aid stream, or other intermediate stream, as disclosed herein in accordance with the present invention. As a composition comprising one or more specific water-soluble polymer in solid form, the composition comprises said polymer(s) but have not been provided with any firefighting chemicals prior to being used in the present method or system. As a composition said one or more specific water-soluble polymer in solid form are the main components of said composition. The composition comprising said one or more specific water-soluble polymer in solid form has not been provided with amounts of water, surfactants, foam booster components, or water-soluble medium used in firefighting before being introduced into the present method or system.

The water-soluble polymer in solid form may be considered as a solid substance in the form of tiny loose fine particles that may flow freely e.g., at least when subjected to forces such as gravity, and/or being shaken or tilted. The water-soluble polymer in solid form is preferably to be provided in the present method in the form of tiny loose fine particles that may flow freely e.g. at least when subjected to forces such as gravity, and/or being shaken or tilted. The water-soluble polymer in solid form may be considered as a powder to be used and added in the present method as a flowing powder, i.e., a powder being able to flow freely e.g., at least when subjected to forces such as gravity, and/or being shaken or tilted. The water-soluble polymer in solid form may be a free-flowing powder, which may be used as such upon introduction into the present process.

The water-soluble polymer in solid form may be provided in dry form, i.e., water-soluble polymer in dry solid form, such as a dry powder. The wordings “dry”, or “dry form” means herein that the water-soluble polymer in solid form comprises essentially water-soluble polymer. The water-soluble polymer in solid form may thus consist of said polymer.

Moreover, different types and combinations of water-soluble polymers are possible to use according to the present invention. According to one preferred embodiment of the present invention, the water-soluble polymer is a combination of water-soluble polymers in solid form. According to one preferred embodiment of the present invention, the water-soluble polymer is a natural polymer. Alternatives of such, e.g., different types of gums or the like, are further described below.

The water-soluble polymer in solid form is, during manufacture of a foam for firefighting, added to a water stream, an aid stream, or a foaming concentrate, wherein if it is added to an aid stream, or a foaming concentrate, such combinations are then added to a water stream to provide said foam for firefighting. The water-soluble polymer in solid form is not mixed with other components into a liquid mixture or powder mixture for further storage before the actual use in firefighting foam production. When the water-soluble polymer in solid form is mixed with other components such as water and foaming concentrate it is done at the actual time use in firefighting foam production in order to e.g., suppress a fire.

According to the present invention there is also disclosed a method for forming a firefighting foam, said method comprising:
adding a water-soluble polymer in solid form to a water supply stream or adding the water-soluble polymer in solid form to an intermediate stream before or when being added to the water supply stream;
adding a foaming concentrate to the water supply stream before, simultaneously or after the water-soluble polymer in solid form is added to the water supply stream, adding the foaming concentrate to the water supply stream before, simultaneously or after the intermediate stream is added to the water supply stream, or wherein the foaming concentrate is part of the intermediate stream,
   and wherein the water supply stream provides an output of the firefighting foam or is flown to a main water supply stream which in turn provides the output of the firefighting foam.

As should be understood from above, either the foaming concentrate is provided as a separate stream to be added into the water supply stream or where the foaming concentrate is part of the intermediate stream and where it is into this that the water-soluble polymer is added before this intermediate stream then is added into the water supply stream.

As mentioned, according to one embodiment, the foaming concentrate is a fluorine-free foaming concentrate.

Furthermore, one or several water supply streams may be used, such as either by using an extra in-mixing water stream to the main water supply stream or the main water supply stream directly. As mentioned, according to one embodiment, the water supply stream provides the output of the firefighting foam.

Moreover, as also said, according to one embodiment, the water-soluble polymer in solid form comprises particles and/or granules, preferably is contained in a powder. The water-soluble polymer in solid form may be a water-soluble polymer in dry solid form, such as in a dry powder form.

The water-soluble polymer in solid form may be selected from the group consisting of hyaluronic acid; polyglutamic acid; alginic acid; alginates, such as sodium alginate or propylene glycol alginate; agar; carrageenan; galactomannan; glucomannan; starch; cellulose, such as methylcellulose, hydroxy ethylcellulose, or hydroxy propyl methylcellulose; gelatin; succinoglucan; pectin; gum, such as gum arabic, guar gum, welan gum, rhamsam gum, locust bean gum, tara gum, gellan gum, xanthan gum, acacia gum, diutan gum, chitosan gum, gum guaicum, neem gum, pistacia lentiscus gum, caranna, gum tragacanth, karaya gum, beta-glucan gum, chicle gum, kino gum, dammar gum, mastic gum, spruce gum, cassia gum, fenugreek gum, konjac gum, or ghatti gum; pysllium seed husk; or a derivative or modification thereof, or a combination thereof. Preferably the water-soluble polymer in solid form may be selected from the group consisting of hyaluronic acid, polyglutamic acid, alginates, such as sodium alginate or propylene glycol alginate, carrafeenan, galactomannan, starch, gelatin, siccinoglucan, pectin, guar gum, welan gum, rhamsam gum, locust been gum, tara gum, gellan gum, xanthan gum, diutan gum, chitosan gum, acasia gum, beta-glucan gum, or a derivative or modification thereof, or a combination thereof.

Furthermore, preferably, the water-soluble polymer in solid form is a natural polymer.

There are several different process set-ups according to the present invention. Again, the core foundation of the present invention is that the water-soluble polymer is provided in a solid form, however otherwise any alternative of a liquid/solid system, suitably a liquid/powder system, may come into play. According to one embodiment, the water-soluble polymer in solid form is added directly into the water supply stream. According to yet another embodiment, the water-soluble polymer in solid form is added directly into the water supply stream in an adding point which differs from an adding point where the foaming concentrate is added into the water supply stream. This embodiment implies that the foaming concentrate is added into the water supply stream in a different stream than the stream containing the water-soluble polymer in solid form. In this regard it should be noted that an intermediate stream may be used which then is added into the water supply stream, either containing the water-soluble polymer in solid form and not the foaming concentrate or containing both of these.

Based on the above, according to one embodiment of the present invention, the water-soluble polymer in solid form is added into a foaming concentrate stream when the foaming concentrate stream is flown into the water supply stream. This implies that the addition point for the water-soluble polymer is into the foaming concentrate stream before, just before or at the point for the addition of the foaming concentrate stream into the water supply stream. Preferably, the water-soluble polymer in solid form is added into a foaming concentrate stream adjacent to or at the position where the foaming concentrate stream is brought in contact with the water supply stream.

Furthermore, as mentioned an intermediate stream may be used according to the present invention. This intermediate stream may be in the form of an aid stream. In line with this, according to one embodiment of the present invention, the water-soluble polymer in solid form is added into an aid stream when the aid stream is flown into the water supply stream or when the aid stream is flown into a foaming concentrate stream when the foaming concentrate stream is flown into the water supply stream.

This implies that an aid stream may be used as an intermediate stream in different ways according to the present invention. The aid stream may be used to ensure slurry formation. In such a slurry, the water-soluble polymer is transported to the water supply stream without being dissolved. Therefore, according to one embodiment of the present invention, the aid stream comprises a water-soluble medium which inhibits the water-soluble polymer in solid form to dissolve and/or swell.

According to yet another embodiment, the water-soluble polymer in solid form is added into an aid stream when the aid stream is flown into the water supply stream and wherein the aid stream is added in an adding point which differs from an adding point for the foaming concentrate into the water supply stream. This alternative corresponds to a process architecture as above, i.e., with different adding points, however in this case an aid stream is used.

As mentioned above, the aid stream should contain a water-soluble medium which inhibits the water-soluble polymer in solid form to dissolve and/or swell. Non-limiting preferred examples of water-soluble medium are glycol, butyl diglycol, mono ethylene glycol, mono propylene glycol, polyethylene glycol, butyl glycol, hexylene glycol, ethanol, isopropyl alcohol, propylene glycol monobutyl ether, dipropylene glycol methyl ether, 1-methoxy-2-propanol, methanol, n-propanol, t-butyl alcohol, or diethylene glycol, or a combination thereof.

As mentioned above, also the water-soluble polymer used may be of different type. Both synthetic and natural polymers are possible, however naturally ones are preferred. According to one preferred embodiment of the present invention, the water-soluble polymer in solid form is a natural polymer, preferably is a polysaccharide, more preferably wherein the water-soluble polymer in solid form is sodium alginate, carrageenan, gum arabic, galactomannan, guar gum, welan gum, rhamsam gum, locust bean gum, cellulose, methylcellulose, glucomannan, tara gum, gellan gum, xanthan gum, acacia gum, diutan gum, chitosan gum, gelatin, alginic acid, succinoglucan, ghatti gum, methyl cellulose, hydroxy ethylcellulose, hydroxy propyl methylcellulose, pectin, starch, or a derivative or modification thereof, or a combination thereof.

It should be noted that also other alternatives are possible according to the present invention. Some non-limiting examples are any type of polysaccharide or combinations thereof. Some specific examples are gums, or modifications or combinations, such as the non-limiting examples gum arabic, guar gum, welan gum, rhamsam gum, locust bean gum, tara gum, gellan gum, xanthan gum, acacia gum, diutan gum, chitosan gum, gum guaicum, neem gum, pistacia lentiscus, caranna, gum tragacanth, karaya gum, beta-glucan, chicle gum, kino gum, dammar gum, mastic gum, spruce gum, cassia gum, fenugreek gum, konjac gum. Other non-limiting examples are different forms of alginates, such as sodium alginate or propylene glycol alginate. Yet other non-limiting examples, some already mentioned and some not, are agar, carrageenan, galactomannan, cellulose, methylcellulose, glucomannan, pysllium seed husks, hyaluronic acid, polyglutamic acid, gelatin, alginic acid, succinoglucan, methyl cellulose, hydroxy ethylcellulose, hydroxy propyl methylcellulose, pectin, starch, caranna, beta-glucan, or a derivative or modification thereof, or a combination thereof.

The present invention also refers to a firefighting system enabling to perform the methods explained above. Therefore, according to one embodiment of the present invention, there is disclosed a firefighting system comprising:
a water supply line;
a foaming concentrate dispenser unit connected to the water supply line; and
a polymer dispenser unit containing a water-soluble polymer in solid form, said polymer dispenser unit being connected to the water supply line or to an intermediate supply line being connected to the water supply line.

In relation to the above it should be stated that a firefighting system according to the present invention may be provided as a totally new installation or as a modification of an already existing firefighting system used e.g. on a ship, a chemical industry plant or at an off-shore installation, such as an oil platform or the like.

According to one embodiment of the present invention, the system also comprises two separate supply lines in connection with the water supply line, wherein the foaming concentrate dispenser unit is connected to one of said two separate supply lines and wherein the polymer dispenser unit is connected to the other of said two separate supply lines.

Moreover, according to yet another embodiment, the foaming concentrate dispenser unit and the polymer dispenser unit are connected to one and the same supply line which in turn is connected to the water supply line.

Furthermore, according to one specific embodiment, the water supply line is connected to a main water supply line.

Examples of polar solvents are acetone, IPA, methyl ethyl ketone (MEK), ethanol, ethyl acetate and so on. Without polysaccharide (e.g. gum) in a foam, the polar solvent will quickly disintegrate the foam landed on top of the liquid surface. By using polysaccharide, such as gum, in the formulation, the foam bubble is protected from destruction and make it possible to build up a foam layer on top of a burning surface and eventually extinguish the fire.

PFAS, also known as per-and poly-fluoroalkyl substances are a collection of manufactured chemicals previously used in firefighting but not so much presently due to environmental regulations. When using PFAS-containing foam concentrates in combination with gum, a wide range of polar solvents can be extinguished. On the other hand, when using synthetic fluorine-free foams (SFFF) the story is quite different. One example of a problematic polar solvent is methyl ethyl keton (MEK). When using PFAS-containing foam concentrate this solvent easily extinguished. However, with SFFF's a fire on MEK is really hard to combat. MEK is partially miscible with water and disintegrates a foam from SFFF quite fast and leaves a open fuel surface. In the fire test standard according to EN 1568-4 the allowed application density of foam is 6.6 l/m²min for a total of 5 minutes. Testing MEK with this application density using an SFFF foam is a total failure, the foam has no chance to build up and the fire is fully engaged even after 5 min. Using a PFAS-containing foam concentrate in the same scenario would take out the fire within 1.5-2 minutes. To extinguish MEK with SFFF in such a scenario the application density must be increased to 22.3 6 l/m²min, an increase with a factor of 3.4, and noteworthy it is out of the scoop for the test standard. The present invention also enables improved extinguishing properties on polar solvents like MEK for fluorine-free foams.

### EXAMPLES

### Example 1

Below there is provided one example according to the present invention. A premix is the mixture intended to exit a fire extinguishing nozzle and containing water as main component but also the chemicals providing the foam, i.e., foam concentrate with surfactants, and additional components such as glycol, and polymer/polysaccharide/gum. Table 1 discloses a calculation of the amount of gum in solid form added to provide a premix, based on increasing content of gum in relation to a 3% fluorine free foam concentrate, the concentrate percentage being referred to the part of the premix.

TABLE 1
3% fluorine free foam concentrate with different gum amounts

| | Gum amount in 3 wt % concentration | | | | | | | |
|---|---|---|---|---|---|---|---|---|
| | 1.7% | 2.0% | 2.5% | 3.0% | 3.5% | 4.0% | 4.5% | 5.0% |
| Gram (g) gum | 0.51 | 0.6 | 0.75 | 0.9 | 1.05 | 1.2 | 1.35 | 1.5 |
| in 1 liter | | | | | | | | |
| premix | | | | | | | | |

Below there is in Table 2 provided the kg gum per minute to the flow for different flow rates (l/min) and corresponding gum amounts in a 3% concentrate.

TABLE 2

| Flow rate | | Corresponding gum amount in a 3% concentrate (kg/min) | | | | | | | |
|---|---|---|---|---|---|---|---|---|---|
| (l/min) | | 1.7% | 2.0% | 2.5% | 3.0% | 3.5% | 4.0% | 4.5% | 5.0% |
| 100 | l/min | 0.051 | 0.060 | 0.075 | 0.090 | 0.105 | 0.120 | 0.135 | 0.150 |
| 250 | l/min | 0.128 | 0.150 | 0.188 | 0.225 | 0.263 | 0.300 | 0.338 | 0.375 |
| 500 | l/min | 0.255 | 0.300 | 0.375 | 0.450 | 0.525 | 0.600 | 0.675 | 0.750 |
| 750 | l/min | 0.383 | 0.450 | 0.563 | 0.675 | 0.788 | 0.900 | 1.013 | 1.125 |
| 1,000 | l/min | 0.510 | 0.600 | 0.750 | 0.900 | 1.050 | 1.200 | 1.350 | 1.500 |
| 1,500 | l/min | 0.765 | 0.900 | 1.125 | 1.350 | 1.575 | 1.800 | 2.025 | 2.250 |
| 2,000 | l/min | 1.020 | 1.200 | 1.500 | 1.800 | 2.100 | 2.400 | 2.700 | 3.000 |
| 5,000 | l/min | 2.550 | 3.000 | 3.750 | 4.500 | 5.250 | 6.000 | 6.750 | 7.500 |
| 7,500 | l/min | 3.825 | 4.500 | 5.625 | 6.750 | 7.875 | 9.000 | 10.125 | 11.250 |
| 10,000 | l/min | 5.100 | 6.000 | 7.500 | 9.000 | 10.500 | 12.000 | 13.500 | 15.000 |

As may be seen above, in a range of from 100 to 10,000 l/min and 1.7% to 5% gum amount the amount of gum to the flow is in a range of 51 g/min to 15 kg/min, which is totally possible to provide according to the present invention.

Furthermore, in relation to a comparative example, a 1% foam concentrate is suitable as the starting point. In the case of a 1% foam concentrate which is alcohol resistant there is, in reference to the example above, needed 1.7%*3=5.1% gum in the concentrate. This is not possible to provide with today known technology as a 1% foam concentrate contains a very small amount of water and together with the large amount of gum this renders stability issues in the concentrate. By use of the method and system according to the present invention, such a 1% foam concentrate is totally possible to provide in the final foam concentrate.

### Example 2

The foaming concentrate formulations herein comprise water, a surfactant package, and a foam booster package. Water being tap water, also called municipal water. The surfactant package contains combinations of anionic, non-ionic and amphoteric surfactants, which are used in firefighting, in different amounts and ratios. The foam booster package contains components that enhance the foam quality by for example give higher expansion ratios, longer drain times etc. It can be different types of glycols and glycol combinations, alcohols and combinations thereof.

### Formulation 1

Formulation 1 is a traditional liquid foaming concentrate supposed to be used at 3% and adapted for addition of water soluble polymer in solid form.

TABLE 3

| | parts per | Actives | Solids | Water in total |
|---|---|---|---|---|
| Formulation 1 | 100 | (%) | (parts per 100) | (parts per 100) |
| Water added | 74.65 | 0.0 | 0.00 | |
| Surfactant | 15.20 | 49.0 | 7.45 | |
| package | | | | |
| Foam booster | 10.15 | 100 | 10.15 | |
| package | | | | |
| | 100.00 | | 17.60 | 82.40 |

In a fire extinguishing process this foaming concentrate will be combined with a water stream, a water soluble polymer in solid form, and optionally an intermediate or aid stream, in a way according to the present invention to create a firefighting premix providing an output of a firefighting foam, upon exit of a foam forming nozzle. Assuming a firefighting foam generating process giving 5000 l/min, the different feeds may be as shown below. In this case the water soluble polymer in solid form, herein gum, is fed at a rate that will correspond to have a 3% foam concentrate with 1.5% gum in the formulation. The densities of water and Formula 1 are about 1 kg/l. Thus, the flows of l/min are about the same in kg/min.

TABLE 4

| Assume flow of | parts | | |
|---|---|---|---|
| 5000 I/min | per 100 | Flow rate | |
| Water | 96.99 | 4850 | I/min |
| Formulation 1 | 2.96 | 147.75 | I/min |
| Gum 1.5% of a 3% | 0.05 | 2.25 | kg/min |
| concentrate | | | |

Looking at the composition of the premix, i.e. when all components are combined and heading towards the outlet, the composition will be as follows. Total water amount is obtained from the water supply and the water content of the formula 1, i.e. foaming concentrate.

TABLE 5

| Premix | parts per | Actives | Solids (parts | Water in total |
|---|---|---|---|---|
| composition | 100 | (%) | per 100) | (parts per 100) |
| Water | 99.2 | 0.0 | 0.0 | |
| Surfactant | 0.45 | 49.0 | 0.22 | |
| package | | | | |
| Foam booster | 0.30 | 100 | 0.30 | |
| package | | | | |
| Gum 1.5% level | 0.05 | 100 | 0.05 | |
| | 100 | | 0.57 | 99.43 |

The way of handling liquid foam concentrate, and separate polymer addition in accordance with the present invention has a lot of freedom. The amounts of surfactants and gum of the premix can easily be adjusted by just changing the feed ratios of the feeds. Below is an example where the feeds are adjusted to give a gum concentration that corresponds to 5% in a 3% liquid foam concentrate. The densities of water and Formula 1 are about 1 kg/l. Thus, the flows of l/min are about the same in kg/min.

TABLE 6

| Assume flow of | parts | | |
|---|---|---|---|
| 5000 l/min | per 100 | Flow rate | |
| Water | 96.9 | 4845 | I/min |
| Formulation 1 | 2.95 | 147.5 | I/min |
| Gum 5% of a 3% | 0.15 | 7.5 | kg/min |
| concentrate | | | |

Firefighting foam systems are frequently designed to be operational during 15 minutes from release. This time frame is set to provide sufficient extinguishing properties, and provide extra time for firefighting departments to arrive on scene. Reviewing the examples above and calculating the amounts needed for these cases gives the following:

Formulation 1 with Gum to Correspond 1.5%:
Feed of formulation 1:2 217 l/min
Feed of gum: 34 kg/min
   Formulation 1 with Gum to Correspond 5%:
Feed of formulation 1:2 217 l/min
Feed of gum: 113 kg/min

The present invention enables a high load of water soluble polymer in solid form providing improved fire extinguishing properties, without the storage stability issues known from conventional firefighting foam compositions, or high energy demanding manufacturing processes.

### Formulation 2

The firefighting foam generating process can be made more simplified and effective by preparing a liquid foaming concentrate without any water addition thereto. Any water contained in such formulations then comes from ingoing materials, such as surfactants, used during the manufacturing. By omitting addition of water from formulation 1, the following composition is obtained. More water may then be added in the premix preparation.

TABLE 7

| | parts | Actives | Solids | Water in total |
|---|---|---|---|---|
| Formulation 2 | per 100 | (%) | (parts per 100) | (parts per 100) |
| Surfactant | 60.0 | 49.0 | 29.4 | |
| package | | | | |
| Foam booster | 40.0 | 100 | 40.0 | |
| package | | | | |
| | 100 | | 69.4 | 30.6 |

The advantage with this is that a firefighting system can be very compact and can easily be fitted in areas where the space is minimal. As example of such installations is on ships, offshore platforms etc. Having this formulation in a 5000 l/min firefighting system will give the following feeds. The densities of water and Formula 2 are about 1 kg/l. Thus, the flows of l/min are about the same in kg/min.

TABLE 8

| Assume flow | parts | | |
|---|---|---|---|
| of 5000 l/min | per 100 | Flow rate | |
| Water | 99.2 | 4960.25 | I/min |
| Formulation 2 | 0.75 | 37.5 | I/min |
| Gum 1.5% of a | 0.05 | 2.25 | kg/min |
| 3% conc. | | | |

And still, it will end up with the same composition in the premix as Formulation 1.

TABLE 9

| Premix | parts | Actives | Solids | Water in total |
|---|---|---|---|---|
| composition | per 100 | (%) | (parts per 100) | (parts per 100) |
| Water | 99.2 | 0.0 | 0.0 | |
| Surfactant | 0.45 | 49.0 | 0.22 | |
| package | | | | |
| Foam booster | 0.30 | 100 | 0.30 | |
| package | | | | |
| Gum 1.5% level | 0.05 | 100 | 0.05 | |
| | 100 | | 0.57 | 99.43 |

With Formulation 2 it will also be possible to make stronger composition or more high concentrated and efficient premix just by changing the ingoing feeds. Either adding more surfactants by increase the Formulation 2 feed or more gum by increasing the gum feed or combinations thereof.

As mentioned above, firefighting foams are frequently designed to be operational during 15 minutes from release. Reviewing the examples above and calculating the amounts needed for these cases gives the following:

Formulation 2 with Gum to Correspond 1.5%:
Feed of formulation 2:563 l/min
Feed of gum: 34 kg/min
   Formulation 2 with Gum to Correspond 5%:
Feed of formulation 2:563 l/min
Feed of gum: 113 kg/min

The foaming concentrate of Formulation 2 gives improved installation advantages, compared to Formula 1, since both tanks and feed pumps can be reduced by about 4 times, providing saving in space, cost and energy.

### Example 3

The comperative foam concentrate formulation used in this example was as follows in Table 10.

TABLE 10

| Ingredients | Parts per 100 | |
|---|---|---|
| Water | 82.90 | |
| Surfactants | 5.60 | |
| Polysaccharide | 1.50 | Prepared as a slurry to be added to the |
| Glycol | 10.00 | other components |
| | = 100 | |

### Preparation of Gum and Glycol Mixtures

To assess the effect of storage of comparative liquid foam concentrate formulations containing a water-soluble polymer, a gum containing formulation in liquid form was subjected to a series of tests. It was investigated how long-term storage effects a gum dispersed in glycol in view of foam quality. Conventional firefighting foams may be provided from stored stored gum/glycol slurries, optionally including water and firefighting surfactants in said slurries.

Two samples of slurries containing gum and glycol was prepared, see Table 10 above. One slurry containing container was stored at room temperature, and another was placed in a heat cabinet set at 60° C. Storage at 60° C. represents usage in hotter climates and simulates also effects of prolonged storage. During the storage the slurry containing containers were inspected regularly to check for changes and anomalies. During storage of the slurries, the gum, which initially was provided in solid form, had separated from the glycol and formed a bottom layer in the containers, and it needed to be vigorously stirred to try and disperse the gum in the glycol yet again.

Upon storing the two gum containing slurries, the gum settles at the bottom after a few hours for both samples. After four weeks storage the settled sediment at the bottom is quite dense and hard when the samples were tried to be redispersed. The sample stored at room temperature showed no additional visual anomaly apart from the sedimentation, but the sample stored at 60° C. showed, in addition to sedimentation, discolouration of the gum, especially at the bottom of the container.

FIG. 1 shows the sample stored at room temperature for four weeks (photo to the left). The container is tilted to show the distinct deposition of the gum at the bottom. The gum can with some effort be re-dispersed but not easily. The photo to the right shows the sample stored at 60° C. Also, here it is a solid-like deposition of gum at the bottom of the container, and it is also hard to redisperse. The gum of the heated sample had started to become yellow at the very bottom of the container. After four months the samples had not changed in appearance.

It is clearly observed that the gum, when prepared as a slurry in a glycol admixture, is seriously affected, when stored, especially at increased temperature.

### Preparation of Firefighting Foams

The above-mentioned slurry samples of gum in glycol were then used to make foam concentrates, which were further tested.

In the following conventional firefighting foam concentrates were prepared, wherein the gum containing slurries (RT and heated) were added to firefighting surfactant mixtures, respectively. The formulations used in this experiment were prepares as follows:

Firefighting surfactant blends were mixed with water and stirred for about 15 min until homogeneous. The containers with the stored gum/glycol slurries were shaken thoroughly to redisperse the before addition to the water/surfactant blends, respectively. After the gum slurry addition, the obtained mixtures were stirred for at least 30 minutes to provide homogenous firefighting foam concentrate mixtures. The products were transferred to plastic bottles after completion and allow to rest overnight before being tested for foam properties. The resulting foam concentrates were expected to be viscous, homogenous liquids.

When preparing the foam concentrates from the gum slurry stored at 60° C., no development of viscosity occurred after 30 minutes of stirring. The sample was allowed to stir for 3 hours and still no viscosity development was provided, see FIG. 2. Normally, an increase in viscosity starts to develop immediately upon contact between the surfactant/water blend and the gum/glycol slurry, first slightly and eventually reaching a high viscosity, an in-can viscosity of about 2000 mPas or more, after about 15-20 minutes contact time. FIG. 2 is a photo of the foam concentrate made from the slurry stored at 60° C. after 3 hours of stirring. The gum was deposited at the bottom of the container and the surfactant rich water phase is on top, as soon as stirring is discontinued.

### Performance Testing of Foams Generated Using Foam Concentrates Containing Aged Gum/Glycol Mixtures

The foam quality was assessed in four different ways, namely:
Expansion ratio
25% Drainage time
Foam stability on acetone
Foam stability on isopropyl alcohol (IPA)

The procedure for testing foam quality is described shortly below and follows the procedure described in the European standard EN 1568 part 3 and 4 (SS-EN 1568-3:2018 and SS-EN 1568-4:218). A premix was made of based on one of the foam concentrates prepared above by dissolving 3% of the concentrate in water. 5 litre premix was prepared, which means that 150 ml foam concentrate is dissolved in 4 850 ml water. The solution is allowed to stir for at least 15 minutes to be homogeneous. The premix is then transferred to a pressure tank fitted to a standardized foam generating branch-pipe. The tank is pressurized to give the right flow of foam solution. The foam is applied onto a backboard and collected in a specially designed “drain pot”. The drain pot is a cylindrical container with a valve fitted in the bottom. The drain pot has a known volume, calibrated by filling it up to the top with water. The drain pot is weighed before receiving a foam sample. When the foam has been collected in the drain pot, it is weighed again, and the weight of the collected foam can be calculated.

The expansion ratio is calculated as the volume of the drain pot divided by the volume of the collected foam. Since the collected foam contains mainly water the specific gravity will be 1.0 and hence, the volume of collected foam is equal to the weight of it.

The 25% drainage time is defined as the time it takes for 25% of the collected foam volume to drain out to liquid again. The valve in the bottom of the drain pot is opened regularly and the liquid is collected in a measuring glass until the required volume is obtained and to time to reach this point is recorded as the 25% drainage time.

A calculation example is hereby provided, wherein it is assumed that a drain pot has a volume of 1 600 ml. In the pot drain say 235 g foam is collected. This will give an expansion ratio of 6.8 (as 1600/235=6.809). The amount of liquid to collect to determine the 25% drainage time will be 59 ml (as 235*0.25=58.75).

The foam stability on polar solvents such as acetone and IPA is determined by adding foam on top of the liquids as follows. 200 ml of acetone or IPA is transferred to a petri dish with 13.5 cm diameter. 300 ml foam is collected in a plastic beaker and poured on top of the solvent. The time it takes to break up the foam is recorded and taken as the result for the foam stability. When foam disappears faster than 1 minute, new shots of foam may be added.

As reference in these tests, the same type of foam concentrate formulation as in table 10 was used, but which gum/glycol slurry had not been stored for four months before foam preparation. The gum/glycol slurry used for the reference was manufactured in connection with the foam preparation.

TABLE 11

| | | | Reference |
|---|---|---|---|
| | Aged gum slurry | | Not aged gum slurry |
| | Stored at RT | Stored at 60° C. | |
| Expansion | 7.0 | not determined | 8.0 |
| ratio | | due to separation | |
| 25% | 15 min 30 s | of foam | 17 min 30 s |
| drainage | | concentrate | |
| time | | | |
| Foam | 20 min | | >20 min |
| stability on | | | |
| acetone | | | |
| Foam | 20 s | | 40 s |
| stability on | (+ new shot) | | (+ new shot) |
| IPA | 4.0 min | | >20 min |
| | (+ new shot) | | |
| | >20 min | | |

It is clearly observed that the gum, when prepared as a slurry in a glycol admixture, is highly affected when stored, especially when stored at increased temperature. The slurry stored for four months at 60° C. was so affected that it did not even swell out in the foam concentrate formulation to give even the slightest viscosity but just deposited on the bottom of the container. Hence, storing gum as a glycol slurry changes the properties of the gum and a foam concentrate formulation containing such, and does not provide the intended function of the gum or foam.

The foam quality for the foam including the gum slurry aged at room temperature does not perform as well as the reference, in view of the decrease in drainage time, and foam stability, which are very important parameters in firefighting performance. Especially problematic, the foam stability on IPA is not desirable as it is demanding an extra shot of foam. From this it is apparent that liquid formulations or slurries including gum are decreasing in foam quality performance over time during storage, especially in when subjected increased temperatures as may be the case in parts of the world having warmer climate.

### Example 4

In this example a comparison between a reference, as above, including a foam provided from a gum/glycol slurry, and foams according to the present invention provided by separate addition of gum in solid form as powder to the surfactants, glycol, and water to provide a premix to be converted to firefighting foam upon exit from a fire extinguishing nozzle.

The foam quality was evaluated for samples according to the invention where gum in solid form was added to surfactants, glycol, and water to provide a premix. The premix was stirred for about 20 minutes before testing the foam quality as described above. For the reference, a slurry of gum and glycol was prepared which then was used in the preparation of the premix. The results from some selected tests are shown below in table 12, where the amount of gum, and gum combination have been varied. The reference test is the same as above but prepared according to the method described here, where the gum is added to the mixture as a slurry with glycol to form the premix.

TABLE 12

| | Test 1 | Test 2 | Test 3 | Test 4 | Reference |
|---|---|---|---|---|---|
| Gum type | A | A | A | A+B | A |
| Amount of | 0.45 | 0.09 | 1.5 | 0.6 of A | 0.45 |
| gum in | | | | 0.4 of B | |
| premix (%) | | | | | |
| Expansion | 7.2 | 7.3 | 6.1 | 7.5 | 8.0 |
| ratio | | | | | |
| 25% | 17 min | 38 min | 1 h 47 min | 1 h 4 min | 17 min 30 s |
| drainage | 30 s | 30 s | | 30 s | |
| time | | | | | |
| Foam | Not tested | >>20 min | >>20 min | >>20 min | >20 min |
| stability on | | | | | |
| acetone | | | | | |
| Foam | Not tested | 50 s | 3 min 30 s | 25 min | 40 s |
| stability on | | (+ new | | | (+ new shot) |
| IPA | | shot) | | | >20 min |
| | | >20 min | | | |
| Foam | Not tested | 2.0 min | Not tested | > 3 h | 2.0 min |
| stability on | | | | | |
| MEK | | | | | |

The foam quality performance is enhanced going from conventional handling and content as the reference to separate addition of gum in solid form enabled at higher concentrations. This is distinctly shown by the excessively prolonged drainage times, and the improved foam stability on e.g. IPA. On MEK, a great effect if found when a combination of gum is used. When foam is applied on MEK with the reference and Test 2 the foam disintegrates within 2 minutes and leaves the fuel surface open, strongly indicating a problematic extinction process when applied in a fire test. However, Test 4 where a combination of gum is used in the same total amount as test 2 this clearly indicates a strong foam formed that does not disintegrate even after 3 hours. The drainage time is also excessively prolonged to over one hour. These results are very strong indicators that fire performance is increased to new levels which are impossible to reach with today's technology preparing it as a foam concentrate, as discussed earlier, or where a gum/glycol slurry is used,

Another important conclusion is that the present method including injecting gum as a powder will allow the addition of extensively increased amounts of gum, not possible to prepare in a concentrate or liquid slurry, which will enhance the fire performance dramatically. This is seen on the prolonged drainage times obtained with the higher amounts added, i.e. an “overload” of gum. Long drainage times is a good indicator of high fire performance since the foam is not dried out quickly due to the heat from the fire. The foam stays moist and mobile for a long time, and not dry and stiff as may happen during extinction. These combinations can be used in many ways, either to enhance fire performance dramatically, or to formulate new less complex foam products that maintains enough performance for the purpose. It is also possible to provide more efficient fire extinguishing equipments requiring less voluminous storage spaces, or equipment complexity.

It is clearly shown that the gum, when prepared as a slurry in a glycol admixture, is seriously affected when stored and will not be able to give the expected performance as given by un-affected gum. The slurry stored for four months at 60° C. was so affected that it did not even swell out in the foam concentrate formulation to give even the slightest viscosity but just deposited on the bottom of the container. Hence, storing gum in or as a glycol containing slurry is not desirable since the gum for some reason change properties when stored and does not give the intended function. The reference used herein is based on newly produced gum/glycol slurry. However, in reality, it is to be noted that in fire extinguishing equipments containers containing gum and glycol may be kept for many years before becoming outdated or used in a fire. Decrease in foaming quality over time would mean difficulties in firefighting, and higher amounts of foam being needed.

The present invention enables “overloading” of water soluble polymers, such as gum, by utilizing powder addition or injection, and the foam properties can be boosted to new levels not possible to obtain from traditional concentrate formulations. Furthermore, using gum combinations it is possible to have a fluorine-free foam, such as synthetic fluorine free foam, that shows very good performance on MEK, and other similar fuels.

1. A method for firefighting by use of a firefighting foam, said method comprising adding a water-soluble polymer in solid form to a water supply stream, or adding the water-soluble polymer in solid form to an intermediate stream before or when the intermediate stream is being added to the water supply stream, and wherein the water supply stream provides an output of the firefighting foam or is flown to a main water supply stream which in turn provides the output of the firefighting foam.

2. The method according to claim 1, wherein a foaming concentrate is added to the water supply stream before, simultaneously or after the water-soluble polymer in solid form is added to the water supply stream or before, simultaneously or after the intermediate stream is added to the water supply stream.

3. The method according to claim 2, wherein the foaming concentrate is a fluorine-free foaming concentrate.

4. The method according to claim 1, wherein the water supply stream provides the output of the firefighting foam.

5. The method according to any of claim 1, wherein the water-soluble polymer in solid form comprises particles and/or granules, preferably is contained in a powder, preferably is a powder, preferably is a powder being able to flow freely.

6. The method according to claim 1, wherein the water-soluble polymer is a natural polymer, preferably the water-soluble polymer in solid form is selected from the group consisting of hyaluronic acid; polyglutamic acid; alginic acid; alginates, such as sodium alginate or propylene glycol alginate; agar; carrageenan; galactomannan; glucomannan; starch; cellulose, such as methylcellulose, hydroxy ethylcellulose, or hydroxy propyl methylcellulose; gelatin; succinoglucan; pectin; gum, such as gum arabic, guar gum, welan gum, rhamsam gum, locust bean gum, tara gum, gellan gum, xanthan gum, acacia gum, diutan gum, chitosan gum, gum guaicum, neem gum, pistacia lentiscus gum, caranna, gum tragacanth, karaya gum, beta-glucan gum, chicle gum, kino gum, dammar gum, mastic gum, spruce gum, cassia gum, fenugreek gum, konjac gum, or ghatti gum; pysllium seed husk; or a derivative or modification thereof, or a combination thereof.

7. A method for forming a firefighting foam, said method comprising:
adding a water-soluble polymer in solid form to a water supply stream or adding the water-soluble polymer in solid form to an intermediate stream before or when being added to the water supply stream;
adding a foaming concentrate to the water supply stream before, simultaneously or after the water-soluble polymer in solid form is added to the water supply stream, adding the foaming concentrate to the water supply stream before, simultaneously or after the intermediate stream is added to the water supply stream, or wherein the foaming concentrate is part of the intermediate stream,
and wherein the water supply stream provides an output of the firefighting foam or is flown to a main water supply stream which in turn provides the output of the firefighting foam.

8. The method according to claim 7, wherein the foaming concentrate is a fluorine-free foaming concentrate.

9. The method according to claim 7, wherein the water supply stream provides the output of the firefighting foam.

10. The method according to claim 7, wherein the water-soluble polymer in solid form comprises particles and/or granules, preferably is contained in a powder.

11. The method according to claim 7, wherein the water-soluble polymer in solid form is a natural polymer.

12. The method according to claim 7, wherein the water-soluble polymer in solid form is added directly into the water supply stream.

13. The method according to claim 12, wherein the water-soluble polymer in solid form is added directly into the water supply stream in an adding point which differs from an adding point where the foaming concentrate is added into the water supply stream.

14. The method according to claim 12, wherein the water-soluble polymer in solid form is added into a foaming concentrate stream when the foaming concentrate stream is flown into the water supply stream.

15. The method according to claim 12, wherein the water-soluble polymer in solid form is added into an aid stream when the aid stream is flown into the water supply stream or when the aid stream is flown into a foaming concentrate stream when the foaming concentrate stream is flown into the water supply stream.

16. The method according to claim 15, wherein the water-soluble polymer in solid form is added into an aid stream when the aid stream is flown into the water supply stream and wherein the aid stream is added in an adding point which differs from an adding point for the foaming concentrate into the water supply stream.

17. The method according to claim 15, wherein the aid stream comprises a water-soluble medium which inhibits the water-soluble polymer in solid form to dissolve and/or swell.

18. The method according to claim 15, wherein the aid stream comprises glycol, butyl diglycol, mono ethylene glycol, mono propylene glycol, polyethylene glycol, butyl glycol, hexylene glycol, ethanol or isopropyl alcohol, propylene glycol monobutyl ether, dipropylene glycol methyl ether,
1-methoxy-2-propanol, methanol, n-propanol, t-butyl alcohol, diethylene glycol, or a combination thereof.

19. The method according to claim 7, wherein the water-soluble polymer in solid form is a natural polymer, preferably is a polysaccharide, more preferably wherein the water-soluble polymer in solid form is selected from the group consisting of hyaluronic acid; polyglutamic acid; alginic acid; alginates, such as sodium alginate or propylene glycol alginate; agar; carrageenan; galactomannan; glucomannan; starch; cellulose, such as methylcellulose, hydroxy ethylcellulose, or hydroxy propyl methylcellulose; gelatin; succinoglucan; pectin; gum, such as gum arabic, guar gum, welan gum, rhamsam gum, locust bean gum, tara gum, gellan gum, xanthan gum, acacia gum, diutan gum, chitosan gum, gum guaicum, neem gum, pistacia lentiscus gum, caranna, gum tragacanth, karaya gum, beta-glucan gum, chicle gum, kino gum, dammar gum, mastic gum, spruce gum, cassia gum, fenugreek gum, konjac gum, or ghatti gum; pysllium seed husk; or a derivative or modification thereof, or a combination thereof;
preferably selected from the group consisting of sodium alginate, carrageenan, gum arabic, galactomannan, guar gum, welan gum, rhamsam gum, locust bean gum, cellulose, glucomannan, tara gum, gellan gum, xanthan gum, acacia gum, diutan gum, chitosan gum, gelatin, alginic acid, succinoglucan, ghatti gum, methyl cellulose, hydroxy ethylcellulose, hydroxy propyl methylcellulose, pectin, starch, or a derivative or modification thereof, or a combination thereof.

20. The method according to claim 1, wherein the water-soluble polymer in solid form is added as a powder in said method, preferably said powder being able to flow freely, at least when subjected to forces.

21. A firefighting system comprising:
a water supply line;
a foaming concentrate dispenser unit connected to the water supply line; and
a polymer dispenser unit containing a water-soluble polymer in solid form, said polymer dispenser unit being connected to the water supply line or to an intermediate supply line being connected to the water supply line.

22. The firefighting system according to claim 21, wherein the system also comprises two separate supply lines in connection with the water supply line, wherein the foaming concentrate dispenser unit is connected to one of said two separate supply lines and wherein the polymer dispenser unit is connected to the other of said two separate supply lines.

23. The firefighting system according to claim 21, wherein the foaming concentrate dispenser unit and the polymer dispenser unit are connected to one and the same supply line which in turn is connected to the water supply line.

24. The firefighting system according to claim 21, wherein the water supply line is connected to a main water supply line.
